(19) United States
(12) Patent Application Publication
(10) Pub. No.: US 2025/0028076 A1
(43) Pub. Date: Jan. 23, 2025

(54) SYSTEM FOR PREDICTING IGNITION POTENTIAL OF LIGHTNING EVENTS

(71) Applicant: Lockheed Martin Corporation, Bethesda, MD (US)

(72) Inventors: Sapna Rao, Littleton, CO (US); Lora Suzanne Koenig, Lakewood, CO (US); Sajit Jumani, Castle Pines, CO (US); Michael Leo Gauthier, Tampa, FL (US)

(21) Appl. No.: 18/758,750

(22) Filed: Jun. 28, 2024

Related U.S. Application Data
(60) Provisional application No. 63/514,177, filed on Jul. 18, 2023.
(60) Provisional application No. 63/610,680, filed on Dec. 15, 2023.
(60) Provisional application No. 63/625,305, filed on Jan. 26, 2024.

(51) Int. Cl. G01W 1/10; A62C 3/02

(52) U.S. Cl. CPC G01W 1/10; A62C 3/0271

(57) ABSTRACT

Technology is disclosed herein to generate an indication of a potential that a lightning event will result in ignition based on satellite data. In an implementation, a computing system obtains data associated with a lightning event. The data includes a location of the lightning event and one or more measurements of the lightning event captured by a sensor. The computing system identifies characteristics of the lightning event based at least on the one or more measurements. The computing system predicts the ignition potential of the lightning event based at least on the lightning characteristics and the fuels characteristics.

### RELATED APPLICATIONS

This application hereby claims the benefit of and priority to U.S. Provisional Patent Application 63/625,305 that was filed on Jan. 26, 2024, and is entitled “SYSTEM FOR PREDICTING IGNITION POTENTIAL OF LIGHTNING EVENTS.” This application also hereby claims the benefit of and priority to U.S. Provisional Patent Application 63/610,680 that was filed on Dec. 15, 2023, and is entitled “SYSTEM FOR PREDICTING IGNITION POTENTIAL OF LIGHTNING EVENTS.” This application also hereby claims the benefit of and priority to U.S. Provisional Patent Application 63/514,177 that was filed on Jul. 18, 2023, and is entitled “SYSTEM FOR PREDICTING WILDFIRES IGNITED BY LIGHTNING.”

### TECHNICAL FIELD

Aspects of the disclosure are related to lightning detection and fire ignition potential.

### BACKGROUND

Lightning-caused ignition of fires are an important part of the cycle of ecological renewal of forests and wildland by promoting biodiversity, nutrient cycling, and fuel reduction. However, wildfires have become increasingly more consequential and impactful around the globe for a number of reasons including misdirected forest management policy (e.g., fire suppression, monoculture plantation), invasive species, encroaching development, and climate change. While humans may cause most fires, natural fires burn more acres and can have disastrous results. In fact, 53% of the average acreage burned in the U.S. from 2018 to 2022 was caused by wildfires resulting from lightning events. Moreover, as humans continue to urbanize forested or wildland areas, wildfires have become much more costly in terms of property damage and the increasing need for fire-fighting operations. Between 2020-2022 alone, the United States collectively spent approximately $30B in damages related to wildfires.

### SUMMARY

Technology, including systems, methods, and devices, is disclosed herein to generate an indication of the potential for a lightning event to cause ignition. In an implementation, a computing system obtains data associated with a lightning event. The data includes a location of the lightning event and one or more measurements of the lightning event captured by a sensor, such as satellite-borne sensor. The computing system identifies observed and/or derived lightning attributes, such as a current duration, for the lightning event based at least on the one or more measurements and fuels characteristics associated with the location of the lightning event. The computing system predicts the ignition potential of the lightning event based at least on the current attributes and the fuels characteristics.

In some implementations, the computing system identifies lightning attributes based on an optical property of the lightning event derived from the data. In some implementations, the ignition potential is further based on weather data and/or topographical data. In the same or other implementations, the data includes Geostationary Lightning Mapper (GLM) data.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

FIG. 1 illustrates an operational environment for generating ignition potentials for lightning events in an implementation.

FIG. 2 illustrates a method of generating an ignition potential for a lightning event in an implementation.

FIG. 3 illustrates an operational environment for generating ignition potentials for lightning events in an implementation.

FIG. 4 illustrates an operational environment for generating ignition potentials for lightning events based on satellite data in an implementation.

FIGS. 5A and 5B illustrate a user interface for an ignition potential prediction system in an implementation.

FIG. 6 illustrates a close-up view of a user interface for an ignition potential prediction system based on a fusion of lightning event data with environmental factors in an implementation.

FIG. 7 illustrates a computing system suitable for implementing the various operational environments, architectures, processes, scenarios, and sequences discussed below with respect to the other Figures.

### DETAILED DESCRIPTION

Systems, methods, and devices are disclosed herein for a system for predicting the potential of a lightning event to cause an ignition. In various implementations, the system includes a prediction engine which is trained to determine an indication of the potential that a lightning event may trigger an ignition based on inputs including lightning data and environmental factors associated with the location, such as weather data, fuels data, topography data, and so on. The prediction engine generates a score (e.g., a potential), score range, or risk categorization which reflects the potential for a lightning event to ignite at a geographic location. By identifying source locations of potential ignitions, fire suppression efforts can be deployed to identify and prevent smoldering or early-stage fires from spreading or growing into active fires or wildfires.

In an implementation, the prediction engine generates an ignition potential based on lightning data and environmental data. The ignition potential is representative of the potential for a lightning event to trigger combustion on the ground. The ignition potential may be a numerical quantity that indicates a potential or a probability of ignition. For example, the ignition potential may be an estimated potential or probability of ignition, where the estimated potential or probability is a numerical value, a range of values, or a risk classification. Whether combustion is ignited by a lightning event may depend on a number of factors, such as duration of the current flow of the lightning event, and environmental factors, such as fuels characteristics of the location of the event, the topography of the location, the weather conditions at the time of the event, and the like. When a lightning event is detected by a sensor, such as a ground-based, airborne, or satellite-based sensor, attributes of the lightning event are estimated based on sensed data. The prediction engine receives and analyzes the lightning event attributes, including the current data, along with real-time environmental data in the vicinity of the event, such as the topography, fuels characteristics, and weather conditions, to generate an ignition potential for the event. In some scenarios, the prediction engine may also be used to classify geographic locations or sectors according to the ignition potential for areas where one or more lightning events have occurred.

In an implementation, the prediction engine receives data of lightning events captured by space-based, airborne, or ground-based sensors. The prediction engine computes an estimate of the ignition potential based on the attributes of the lightning event derived from the data together with weather and fuels data correlated by time and location to the event. The prediction engine may also include other data, such as data relating to ground conditions (e.g., topography) of the event locations, in computing the ignition potential. In some scenarios, the prediction engine is a computational engine which receives an input of the lightning event data along with data relating to environmental factors, such as weather, fuels data, and topographical information, and computes the ignition potential based on the data. In other cases, the prediction engine may be an artificial intelligence model.

In some implementations, the prediction engine is an artificial intelligence model (e.g. using a model architecture of an artificial neural network, deep neural network, or another AI model architecture) trained on past/historical lightning events, lightning-induced ignition events, and correlated historical weather data and fuels data to estimate the ignition potential of a lightning event. The artificial intelligence model generates a prediction or score which reflects the ignition potential of a lightning event based on the lightning signature, derived lightning metrics, and environmental conditions. The input layer of the artificial intelligence model receives input or feature vectors or arrays (i.e., one-dimensional or multi-dimensional data structures) of input data corresponding to sensor data, tabular data derived from the sensor data, or a combination, where the sensor data is obtained by a space-based and/or ground-based sensor which detects and captures emissions in visible, radio (e.g., microwave), infrared, ultraviolet, x-ray, gamma, or other wavelength bands. For example, the input data for the neural network model may include lightning data collected by the Geostationary Lightning Mapper (GLM) or other satellite-borne optical sensor operating in a near-infrared wavelength band. The input data may also include lightning event data from ground-based or airborne lightning detection networks. The artificial intelligence model may be trained on data for various types of lightning phenomena and parameters (such as polarity, multiplicity, flash area, flash energy). Other inputs for the artificial intelligence model for training and inference gathered from the data may include environmental conditions such as cloud type, cloud altitude, and cloud reflectivity associated with the observed/detected lightning events.

Lightning event data, as employed herein, can include various data related to sensor data or imaging data, metadata relating to sensor data or imaging data, or tabular data determined based on any of the aforementioned data types. For example, the sensor data might be captured as an image or series of images comprising pixel data, which are then processed to determine properties or characteristics of the pixels. These properties or characteristics can include representations of the pixel data itself, or include representations of changes in the sensed data over time, changes in magnitude, or metadata related to the sensed data including location, time, satellite identity, orbital properties of the satellite, altitude of the terrain, sensor characterization data (i.e., sensor normalization or sensor calibration data), image compression types, or any similar properties and characteristics for video data or sequential imaging data. Moreover, if image compression, video compression, or encryption is employed, then the sensor data as provided might not have a direct correspondence to pixels captured by a sensor. Thus, the lightning event data can take various forms and include various data, metadata, or data types, and these various forms can be employed for the lightning event and ignition potential processing described herein.

When the sensor data or imaging data is provided as pixel data for selected geographic regions, such as GLM data, then each pixel of the lightning event data can include optical properties (e.g., RGB values) and optical energy data (e.g., total optical energy, peak optical energy, radiance, reflectance, intensity, luminosity). This GLM data can also include temporal characteristics of detected lightning events, such as an estimated duration in milliseconds based on, for example, the time of exposure and refresh rate of the optical sensor. GLM metadata might include timestamps of the data and location data for the area on the ground (e.g., latitude, longitude) corresponding to the pixels of the sensor data as well as distance (e.g., horizontal propagation).

The input vector to the artificial intelligence model of the prediction engine also includes derived metrics for the detected lightning events, such as the duration and/or energy of a given lightning event. In various implementations, the artificial intelligence model receives structured or tabular data (e.g., GLM data) for detected lightning events and derives associated lightning-related metrics, such as a current duration or energy metrics for electrical energy events (including lightning events). The current duration of a lightning event is the flow of electrical current associated with a lightning event, often lasting tens to hundreds of milliseconds during or immediately after the visible flash. The current duration may be estimated based on optical properties of a lightning event, an estimated distance or length of the lightning path, an estimated temperature of a lightning event, atmospheric conditions, and so on. The current duration may be calculated as an estimated value with a margin of error or a range of values corresponding to a specified level of confidence.

In some implementations, a lightning attribute is a calculated quantity that is representative of the current of a lightning event and that is used in computing an ignition potential for the event. For example, representative values which may be inputs in computing the ignition potential include the magnitude of the current, the energy discharged in an event, or the duration of the current. Values which are representative of lightning attributes may be derived from optical attributes of the lightning event derived from GLM data.

In some implementations, the existence of a current and the magnitude of a current of a lightning event may be determined based on optical energy (e.g., measured in Joules), flash emission metrics, and/or electrostatic or electric field data, including changes to and duration of electrical fields generated by a lightning discharge, captured by space-borne detectors. For example, Fairman and Bitzer describe a method of detecting the existence of a continuing current in a lightning event based on satellite-based optical data to overcome various shortcomings in ground-based detection methods. The method predicts whether a lightning event captured in space-based optical data (i.e., GLM data) contained a current using a multiple logistic regression model trained on optical attributes captured by ground-based high-speed video and electric field changes captured by ground-based, airborne, and space-based detectors. The optical attributes include the duration of the optical emission as well as event channel luminosity, propagation distance, maximum optical energy, and a maximum area of the optical emission span. The electric field changes are captured in voltage profiles detected by ground-based VLF/LF meters and energy profiles detected by the GLM optical sensor. (Fairman, S. I. & Bitzer, P. M. (2022). “The detection of continuing current in lightning using the Geostationary Lightning Mapper,” Journal of Geophysical Research: Atmospheres, 127, https://doi.org/10.1029/2020JD033451).

Other variables of the input vector to the artificial intelligence model include data relating to environmental factors at or around the time and location of a lightning event. Environmental factors include weather or atmospheric data and ground conditions, such as topography data, terrain data, and/or fuels data relating to the flammability of the organic material in the area of the event (e.g., moisture level of the vegetation or ground cover, as well as derived indices related to the flammability of ignition propensity of the fuel). Data relating to environmental factors may be obtained by extracting data correlated to the time and location for the lightning event from freely available and/or proprietary databases, such as weather, topographical, and fuels databases, and processing to determine a normalized or scaled value for input to the artificial intelligence model.

To train the artificial intelligence model, a dataset is generated based on correlating historical lightning data, historical environmental conditions data, and historical ignition or wildfire data indicating whether ignition occurred as a result of a corresponding lightning event. The training data includes input vectors corresponding to a given set of conditions and ignition data.

In an implementation, to generate a set of training data for a given lightning event, variables relating to the ground conditions in the area of the lightning event (e.g., fuels, vegetation, ground moisture, altitude, terrain, topography) and to weather conditions at the time of the event (e.g., temperature, humidity, wind speed, precipitation, barometric pressure) are quantified. To quantify the conditions, the parameters (e.g., temperature values) may be pre-processed to normalized or scaled values (e.g., converted to dimensionless quantities over a specified range). The lightning data is then grouped or bucketized according to the various combinations of values of the variables.

In generating the training data, for each combination of values of the variables (i.e., the variables relating to the lightning discharge, ground/fuels conditions, and weather conditions), an ignition potential (i.e., an indication of the potential that ignition occurred) is calculated. The estimated potential of ignition may be further used to predict the risk associated with the given set of values (e.g., severe, high, moderate, low). In some implementations, the potential estimation for a particular bucket of values in the training data is based on aggregating the number of lightning events of the bucket with those of adjacent buckets.

When the trained model is used for inference, the output generated by the trained model reflects an estimate of the potential of a lightning event to cause an ignition. The artificial intelligence model may be a multilayer perceptron, an artificial neural network (ANN), or other type of deep learning neural network such as a convolutional neural network (CNN), a recurrent neural network (RNN) model, such as a Long Short-Term Memory (LSTM) model or a Gated Recurrent Unit (GRU) model, or a transformer-based network. In some scenarios, the artificial intelligence model may be a hybrid of common model architecture types.

During inference, the trained artificial intelligence model receives a vectorized input corresponding to a detected lightning event from a space-based detector. The vectorized input includes observed and derived characteristics of the lightning event, along with weather and ground/fuel conditions in the vicinity of the lightning event converted to normalized or scaled values. The weather and ground conditions for a detected lightning event are determined based on the time and location data of the event which are used to access topography, fuels, and weather conditions from databases. An input vector is formed in the same manner as the input vectors of the training data and fed into the artificial intelligence model. Based on its training, the artificial intelligence model produces an output value reflecting an estimate of the potential that ignition will occur from the observed lightning event.

The output of the artificial intelligence model may be configured for display in a user interface such as a web browser or mobile application. The user interface may include a map based on the location of an identified lightning event or storm system along with visual indications of the geolocations of lightning events and the associated ignition potential or fire-risk prediction.

In the same or other implementations of the technology disclosed herein, the map data may be received by end-users via an application programming interface (API) hosted by the prediction system. The map data may also be used to render a geographic map for display in a graphical user interface on an end-user's computing device. For example, the geographic map may indicate the location of lightning events for a storm system along with the time of event and with sectors or locations color-coded according to ignition potential. In some implementations, the prediction engine also outputs data relating to a spread of a fire from the ignition point, such as assigning a potential to or color-coding areas in the vicinity of a lightning event which indicate the direction and speed of a potential wildfire propagating from the ignition point. In some implementations, the prediction system generates an automatic notification to a subscriber of the prediction system of potential ignitions, such as sending an email, text message, direct message, or robocall to alert the subscriber to the time and location of a lightning event when the ignition potential is greater than a threshold value (e.g., greater than 20%).

In an implementation, the ignition prediction system executes a prediction engine comprising an artificial intelligence (AI) or machine learning (ML) model, such as a convolutional neural network architecture or recurrent neural network architecture, e.g., a Long Short-Term Memory (LSTM) model. The artificial intelligence model architecture is trained on historical data correlating lightning event information, environmental data (e.g., weather data, fuels characteristics, topography data), and fire event data, such as data from U.S. Forest Service databases. The historical data used for training may be unfiltered to include all-cause fires or filtered for ignition caused by lightning, for ignition by an unknown cause, or for a combination of ignition caused by lightning and by an unknown cause.

In various implementations, the prediction engine of the ignition prediction system is trained on an integrated training dataset including lightning event data from historical observation systems, such as GLM data from a Geostationary Operational Environmental Satellite (GOES), ground-based lightning detection networks, or other sources (e.g., Lightning Image Sensor on the NASA TRMM satellite, the Lightning Imager (ESA LI) onboard the ESA Meteosat-12). The lightning event data is correlated to historical wildfire data in the integrated training dataset.

In addition to lightning event data and the historical wildfire data, the integrated training dataset also includes data relating to or characteristics of fuels—the combustible organic material which fuels wildfires. Naturally occurring combustible biomass which can fuel a lightning-caused fire and includes live and dead vegetation, organic matter on the forest floor, logging debris, bark and tree canopies, and peat or other organic soils. Fuels data can include the fuels, vegetation type, fuel moisture, and indices related to fuel and ignition propensity of fuels. Other training data includes environmental data which would influence the ignition and spread of a fire, such as temperature, wind data (e.g., speed, gusts, direction), and humidity before, at the time of, and after a lightning event, and data relating to the topography in the vicinity of a lightning event, such as slopes, valleys, and ridges, which can affect both wind and fire behavior.

During training, the prediction engine (i.e., the artificial intelligence model) receives the lightning event data along with the environmental data and predicts an ignition potential. The predicted ignition potential is compared to ground truth data, i.e., whether the event actually caused ignition. Based on sufficient training, the neural network converges to a trained AI model which can be used for inference to characterize ignition potentials associated lightning events with corresponding environmental data.

Once trained, the prediction engine receives as input lightning event data from a satellite-based or ground-based detector, such as optical (e.g., infrared), radiofrequency, electric field, magnetic field, or high-energy radiation detector. Other inputs to the prediction engine include data relating to environmental conditions in the vicinity of a lightning event or suspected lightning event which would influence the ignition and spread of a fire, such as temperature, barometric pressure, wind data (e.g., speed, gusts, direction), and relative humidity before, at the time of, and after a lightning event. Other inputs to the prediction engine can include data relating to the topography in the vicinity of a lightning event, such as altitude, slopes, valleys, and ridges, which can affect both wind and fire behavior. Based on its training, the prediction engine generates the ignition potential for the lightning event, such as a numerical score indicative of the potential of ignition, a score range, or a risk categorization (e.g., “severe,” “high,” “moderate”), that ignition occurred at the ground event location.

The technical effect of the technology disclosed herein includes early identification and prevention of lightning-caused ignition to optimize the deployment of fire-fighting operations. Because the prediction engine is trained with satellite-sourced data, the prediction system is well-suited for areas which are difficult to access and monitor using ground-based methods. Moreover, policies and decisions relating to the deployment of fire-fighting operations can be tailored according to the estimated or predicted potential for ignition, thereby optimizing the use of critically important but often overtaxed fire-fighting resources. The output of the prediction system can provide multi-day advanced notice of ignition potential to enable asset deployment for detection and mitigation of early fires. The prediction system may not only reduce billions of dollars in wildfire costs, but also, and more importantly, help save lives.

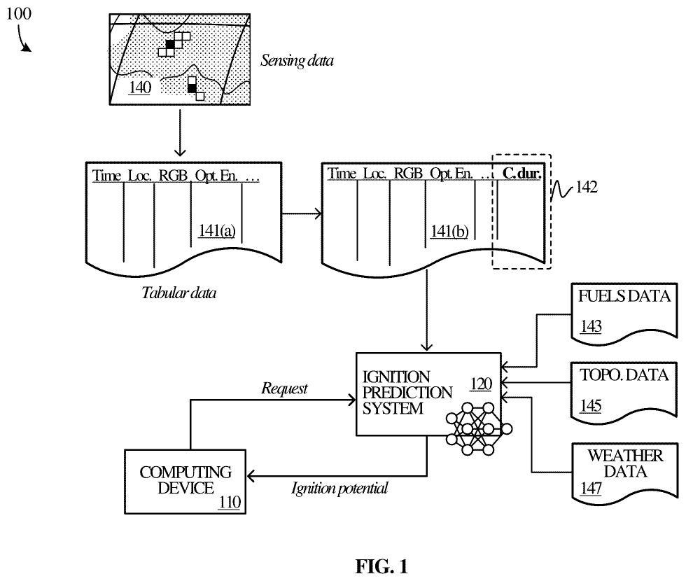

Turning now to the Figures, FIG. 1 illustrates operational architecture 100 for ignition prediction of lightning events in an implementation. Operational architecture 100 includes computing device 110 and ignition prediction system 120. Ignition prediction system 120 receives input data including satellite sensing data 140, tabular data 141 (shown in various stages of operation as 141(a) and 141(b)) derived from satellite sensing data 140, fuels data 143, topographical data 145, and weather data 147.

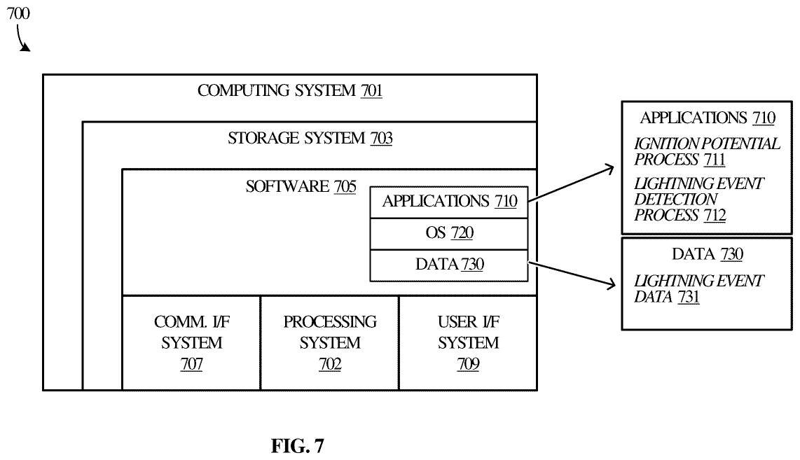

Computing device 110 is representative of any computing device capable of interacting with ignition potential system 120, including displaying a user interface of ignition potential system 120, examples of which include desktop and laptop computers, tablet computers, mobile phones, of which computing device 701 in FIG. 7 is broadly representative. Computing device 110 communicates with ignition potential system 120 via one or more internets and intranets, the Internet, wired or wireless networks, local area networks (LANs), wide area networks (WANs), and any other type of network or combination thereof. A user interacts with the ignition potential system 120 via a user interface of an application hosted by ignition potential system 120 and displayed on computing device 110.

Ignition prediction system 120 is representative of one or more computing services capable of generating an ignition potential based on input data derived from sensing data 140 or tabular data 141 and other inputs and communicating with endpoints such as computing device 110. Ignition prediction system 120 employs one or more server computers co-located or distributed across one or more data centers connected to computing device 110. Examples of such servers include web servers, application servers, virtual or physical servers, or any combination thereof. Computing device 110 communicates with ignition prediction system 120 via one or more internets and intranets, the Internet, wired and wireless networks, local area networks (LANs), wide area networks (WANs), and any other type of network or combination thereof.

In an implementation, ignition prediction system 120 includes an artificial intelligence computing architecture trained to generate an estimate of the potential for ignition. In some implementations, ignition prediction system 120 is an artificial intelligence model. Ignition prediction system 120 may be trained on an integrated dataset including lightning event data from a database, weather data, topography data, and fuels data. The integrated dataset is used in conjunction with historical wildfire data to produce an AI model that generates a geolocated ignition potential.

Sensing data 140 is representative of data captured by space-based, airborne or ground-based optical sensors, such as an optical sensor onboard a satellite, drone, aircraft, or weather balloon. Tabular data 141 includes data corresponding to lightning events detected by the optical sensors in sensing data 140. Tabular data 141 may be derived from sensing data 140 by processing sensing data 140 and across a time sequence of images using equations, algorithms, machine learning, or artificial intelligence methods. Tabular data 141 may also include lightning event data gathered from ground-based lightning detection systems/networks as well. For example, a convolutional neural network may be trained to identify lightning events in sensing data 140 and to classify the lightning attributes. The output of the CNN may be a table or spreadsheet of data for the detected lightning events, including the type, the geolocation and altitude, the date and time, duration, propagation distance, as well as other parameters, such as pixel intensity, optical emission data, weather data, frequency of occurrences, and so on.

For each lightning event, tabular data 141 includes geolocation data, such as coordinates of the geographic areas or event locations. Tabular data 141 includes time and location data as well as attributes of the lightning event as predicted by the sensing system. Fuels data 143, topography data 145, and weather data 147 are representative of data from historical databases from which information correlated to the time and location of tabular data 141 are correlated. In various implementations, fuels data 143, topography data 145, and/or weather data 147 are highly resolved with respect to spatial and/or temporal parameters to provide more precise environmental information about the event location to ignition prediction system 120. For example, fuels data 143, topography data 145, and/or weather data 147 may be specified according to an area on the order of 100 meters by 100 meters to provide more accurate information relating to ground conditions.

Tabular data 141(b) includes current duration data 142, a metric computed based on other data in tabular data 141. For example, current duration data 142 may be generated based on optical energy or emission properties (e.g., flash intensity) of the lightning events which are captured by the satellite sensing device and quantified in tabular data 141. To generate current duration data 142 as well as other derived metrics, tabular data 141(a) may be processed by a data processing engine (not shown) prior to input to ignition prediction system 120 or by ignition prediction system 120 itself.

In a brief, non-limiting, operational example of operational architecture 100, a user may request ignition potentials for observed lightning events from ignition prediction system 120 via computing device 110. Sensing data 140 and tabular data 141 are transmitted to ignition prediction system 120 which generates an ignition potential for the observed lightning event(s) listed in tabular data 141 for an area of interest indicated by the user. Ignition prediction system 120 generates an estimate of the ignition potential based on attributes of the lightning data from sensing data 140 and/or tabular data 141, along with environmental data selected from fuels data 143, topography data 145, and weather data 147 according to the time and location of the lightning event. The ignition potential is then transmitted for display to computing device 110.

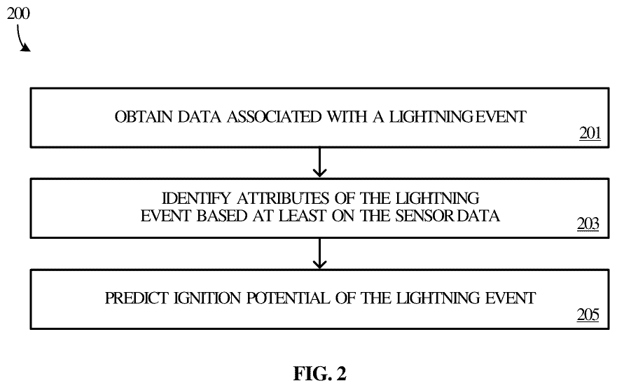

FIG. 2 illustrates process 200 performed by a computing system for computing an ignition potential of a lightning event, such as ignition prediction system 120 of FIG. 1, in an implementation. The prediction system may execute on any one or more of the computing systems according to program instructions which direct the prediction system to function as follows, referring parenthetically to the steps in FIG. 2 and in the singular for the sake of clarity.

In process 200, a computing system obtains data associated with a lightning event (step 201). In an implementation, a sensor device or system captures data which indicates the time and location of the lightning event and one or more measurements of the lightning event. In an implementation, the computing system receives tabular data associated with the lightning event derived from the sensor data. In some scenarios, the computing system receives sensor data capture by the sensor device. The sensor may be a GLM sensor (e.g., an optical transient detector) onboard a GOES-16 or GOES-17 satellite or other space-based, airborne, or ground-based sensor.

The computing system identifies attributes relating to the lightning event based on the data (203). In an implementation, the computing system determines one or more values relating to a quantity of energy delivered to the ground from the lightning event, such as a current duration.

In various implementations, the computing system identifies environmental factors, such as fuels characteristics and weather data, associated with the time and location of the lightning event. For example, the computing system may receive information relating to the fuels at the observed ground event location, such as the type of forest or ground cover, native species of the location, information relating to past or recent wildfires in the area, and so on. The computing system may also receive fuels data such as derived fuel metrics or other data from fire behavior models or energy release models. The computing system also receives environmental data reflecting environmental factors for the location and time of the lightning event. The environmental data can include weather conditions at or around the time of the event and topographical information. The computing system may access various databases for environmental data and select the data for computing the ignition potential based on the time and location of the event.

The computing system predicts the ignition potential of the lightning event (step 205). In an implementation, the computing system executes an engine which predicts the ignition potential based on inputs including the lightning event characteristics and the fuels characteristics. The engine may also receive other inputs, such as weather data at the time and location of the event, topographical data, or information about the terrain in the area of the ground event location. Based at least on the lightning event characteristics and the fuels characteristics, the computing system generates a quantitative or qualitative value which is representative of the ignition potential of the lightning event. The value may be a numerical score indicative of the risk or potential that ignition occurred as a result of the lightning event. Alternatively, the value may be a prediction of the severity of the risk that ignition occurred due to the lightning event (e.g., “severe,” “high,” “moderate,” “low”).

In an implementation, the computing system includes an AI model trained on lightning event data correlated to historical wildfire data. The training data may also include data relating to environmental factors at or around the time of the lightning event, such as weather, topography, and fuels data.

In some implementations, to predict the ignition potential, the computing system generates an input vector of attributes associated with the lightning event including lightning attributes and data relating to environmental conditions at the time and location of the event. In an implementation, the input vector is a feature vector for input to an artificial intelligence model. For example, the feature vector may include numerical values relating to the lightning attributes and the environmental conditions. Based on its training, the AI model generates an ignition potential, such as a numerical estimate that an ignition was triggered by the event or a prediction of the risk of wildfire associated with the event. Based on the observed lightning attributes and the environmental data, the prediction system computes an ignition potential for the lightning event.

Upon generating the predicted ignition potential, the computing system may render the information in a user-friendly format and transmit the information to a user computing device for display, for example, via an API hosted by the prediction system. The user-friendly format may be a geographic map plotting the location of the event annotated with event information (e.g., date, time, coordinates, ignition potential). The computing system may also provide information which was used by the prediction engine to compute the ignition potential, such as the weather conditions in the vicinity of the event. In some implementations, the computing system may proactively transmit event data to the user computing device when the ignition potential is above a predetermined threshold.

In a singular, non-limiting, implementation (which is not to imply that other implementations in this disclosure are limiting), a lightning event detection system identifies lightning events based on the satellite sensor data. In some scenarios, the detection system may be a convolutional neural network for image processing or computer vision, receives real-time or near real-time sensor or image data of geographic areas including lightning event signatures. In this instantiation, lightning signatures may be visual signatures captured by an optical sensor or infrared signature and identified by the detection system. In some implementations, the lightning event signature may be electromagnetic or high-energy radiative (e.g., X-ray or gamma ray). Lightning measurements are determined by the detection system for the detected lightning events which can then be used as input to an ignition prediction system. For example, optical sensors onboard a satellite may capture an image of an area and a CNN model may detect lightning signatures within the image data. The CNN may output attributes of the lightning events based on the detected signatures for input to an ignition prediction system. For example, the CNN which detects the lightning signature may also be trained to estimate electrical characteristics from the satellite data based on historical lightning data, including electrical characteristics, and imaging data.

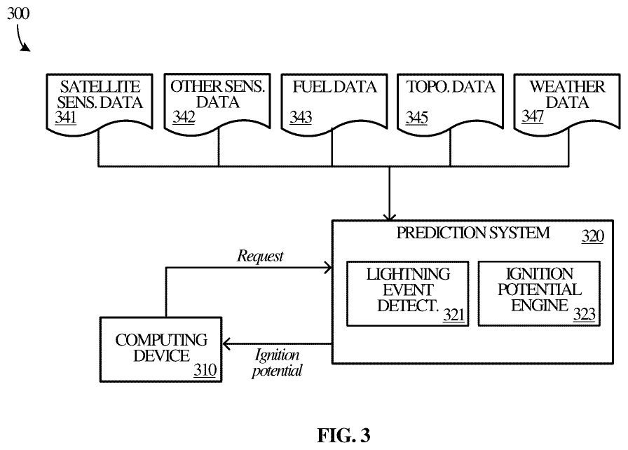

Turning now to FIG. 3, FIG. 3 illustrates operational architecture 300 for ignition prediction of lightning events in an implementation. Operational architecture 300 includes computing device 310 and prediction system 320 for predicting ignition. Prediction system 320 includes lightning event detection component 321 and ignition potential engine 323. Prediction system 320 receives input data including satellite sensing data 341, other sensing data 342 captured by ground-based or airborne sensing devices, fuels data 343, topographical data 345, and weather data 347.

Computing device 310 is representative of any computing device capable of interacting with prediction system 320, including displaying a user interface of prediction system 320, examples of which include desktop and laptop computers, tablet computers, mobile phones, of which computing device 701 in FIG. 7 is broadly representative. Computing device 310 communicates with prediction service 320 via one or more internets and intranets, the Internet, wired or wireless networks, local area networks (LANs), wide area networks (WANs), and any other type of network or combination thereof. A user interacts with the prediction service 320 via a user interface of an application hosted by prediction service 320 and displayed on computing device 310.

Prediction system 320 is representative of one or more computing services to endpoints such as computing device 310. Prediction service 320 employs one or more server computers co-located or distributed across one or more data centers connected to computing device 310. Examples of such servers include web servers, application servers, virtual or physical servers, or any combination thereof. Computing device 310 communicates with prediction service 320 via one or more internets and intranets, the Internet, wired and wireless networks, local area networks (LANs), wide area networks (WANs), and any other type of network or combination thereof.

Ignition potential engine 323 is representative of one or more computing services capable of generating an ignition potential based on input data received by prediction system 320 including lightning event data derived from satellite sensing data 341 and/or other sensing data 342 captured by ground-based or airborne sensing devices. In an implementation, ignition potential engine 323 includes an artificial intelligence computing architecture trained to generate an estimate of the potential for a lightning event to ignite. In some implementations, ignition potential engine 323 is a recurrent neural network, such as an LSTM model. Ignition potential engine 323 may be trained on an integrated dataset including observed lightning attribute data from a database, such as the GLM lightning dataset, and environmental factors associated with the location, such as weather data, topography data, and fuels data. The integrated dataset is used in conjunction with historical wildfire data to produce an AI model that generates geolocated ignition potential.

Satellite sensing data 341 is representative of data captured by satellite device, such as an infrared or optical sensor, and includes tabular data corresponding to lightning events detected by the optical sensors along with the coordinates of the geographic areas or event locations interpolated from the sensor data for the detected lightning events. Other sensing data 342 is representative of data captured by a sensing device, such as a ground-based radiofrequency sensor or airborne sensing devices onboard drones, balloons, and the like, and includes tabular data corresponding to lightning events detected by optical sensors along with geographic location data of areas or events. The tabular data from satellite sensing data 341 and other sensing data 342 includes time and location data as well as attributes of the lightning based on optical properties measured or detected by the optical sensor. Fuels data 343, topography data 345, and weather data 347 are representative of data from historical databases from which information correlated to the time and location of satellite sensing data 341 are correlated.

In a brief operational example of operational architecture 300, a user requests lightning event ignition potential information from prediction system 320 via computing device 310. Satellite sensing data 341 and/or other sensing data 342, such as infrared sensor data captured in real-time or near real-time, is transmitted to lightning event detection component 321 of prediction system 320 which examines the data for a lightning signature, such as an infrared signature. When a lightning event is detected, the time, location, and attributes of the event are predicted.

Ignition potential engine 323 generates an estimate of the ignition potential based on the attributes of the lightning event along with environmental data selected from fuels data 343, topography data 345, and weather data 347 according to the time and location of the lightning event. The ignition potential is then transmitted for display to computing device 110.

In FIG. 3, operational environment 300 depicts a brief example of process 200 as employed by elements of operational environment 300 in an implementation. Computing device 310 displays a user interface (not shown) where a user requests and receives information relating to lightning events including ignition potentials generated by prediction system 320.

In an implementation, prediction system 320 generates a user interface for display on computing device 310 which includes a geographic map of an area of interest to the user. For example, the user may be interested in receiving information relating to ignition potential due to lightning activity in a particular area.

Prediction system 320 receives satellite sensing data 341 for the area of interest. For example, a sensor on board a satellite (not shown) in geosynchronous orbit captures sensor data of the area and returns the sensor data via a ground station receiver (not shown) to prediction system 320. Lightning event detector 321 includes an artificial intelligence architecture for predicting ignition potential based on the sensor data for lightning events in the area of interest. Upon identifying a lightning event or potential lightning event, lightning event detector 321 determines the time and location of an event and computes additional prediction parameters for the event.

With the attributes of lightning event determined, ignition potential engine 323 receives event data along with environmental data including data selected from fuels data 343, topographical data 345, and weather data 347 according to the time and location of the event. Based on the event data and the environmental data, ignition potential engine 323 generates an estimate of the ignition potential of the event.

Prediction system 320 generates output for display in the user interface of computing device 310 which includes the ignition potential of the detected lightning event. In an implementation, prediction system 320 configures a geographical map of the area of interest around the location of the event. The geographical map may include information relating to the event, such as the time and geographical coordinates of the event as well as estimates of the electrical characteristics of the event. The geographical map may also include environmental data used by ignition potential engine 323 to generate the ignition potential. For example, the geographical map may include wind, temperature, and humidity data for the area of the event.

In still other implementations, prediction system 320 may include an automatic notification system (not shown) by which a user subscribed to prediction system 320 can receive notifications of lightning events with an explicit request for the information. For example, a user may specify an area of interest for ongoing monitoring. When prediction system 320 detects and confirms a lightning event in the area, the automatic notification system may generate an electronic notification (e.g., email, text message, or robocall) to notify the user of the event along with the estimated potential for ignition. In some implementations, the electronic notification includes a hyperlink by which the user can view a geographic map of the area of interest indicating the location of the lightning event, event data, and so on.

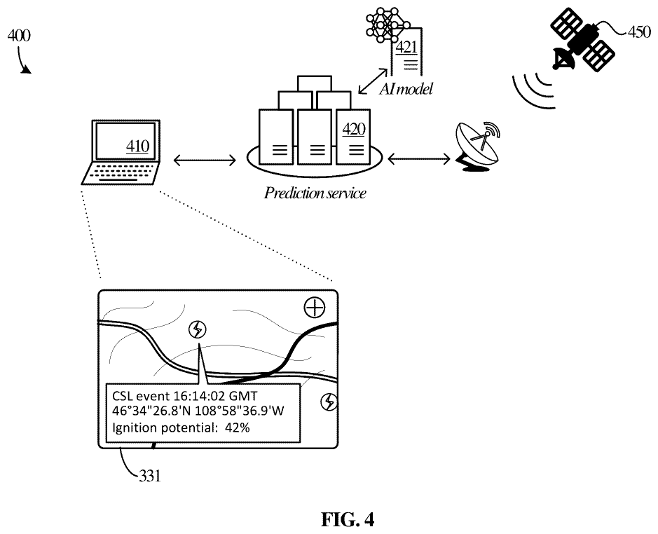

FIG. 4 illustrates operational architecture 400 for a prediction system for generating an ignition potential of a lightning event in an implementation. User computing device 410, of which computing device 110 of FIG. 1 is representative, is in communication with prediction system 420, of which prediction system 120 of FIG. 1 is representative. Prediction system 420 hosts or is in communication with AI model 421, a trained AI model for generating ignition potentials of lightning events detected in data received from one or more sensing or lightning detection devices onboard satellite 450. In various implementations, AI model 421 is a convolutional or recurrent neural network model trained on historical data including lightning event data correlated to wildfire data and environmental data.

In operation, computing device 410 communicates with cloud-based prediction service 420 to receive lightning event data including ignition potentials. Prediction system 420 receives optical and/or infrared sensor data. Prediction system 420 determines attributes of the lightning event and transmits the data about the event to AI model 421. AI model 421 receives the attributes of the lightning event along with environmental data for the area at or around the time of each of the detected events. Based on the event data and the environmental data, AI model 421 computes an indication of the potential (e.g., a numerical score indicative of the potential or probability) that an event will cause ignition according to its training.

Computing device 410 displays user interface 431 hosted by prediction system 420 which displays a geographic map including lightning events detected from the data. As illustrated in user interface 431, prediction system 420 includes information relating to the detected events such as the date and time of the event, latitude and longitude of the event, and the ignition potential determined by AI model 421.

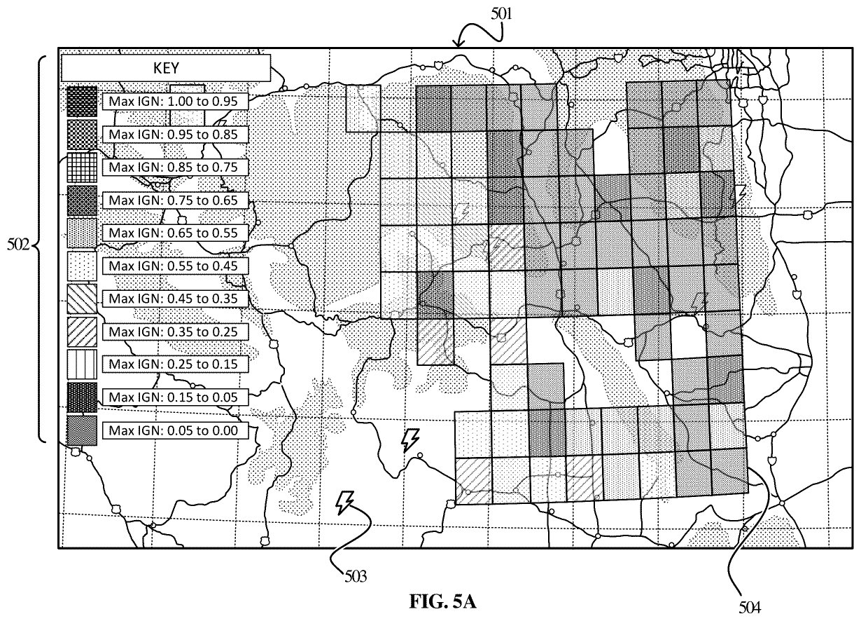

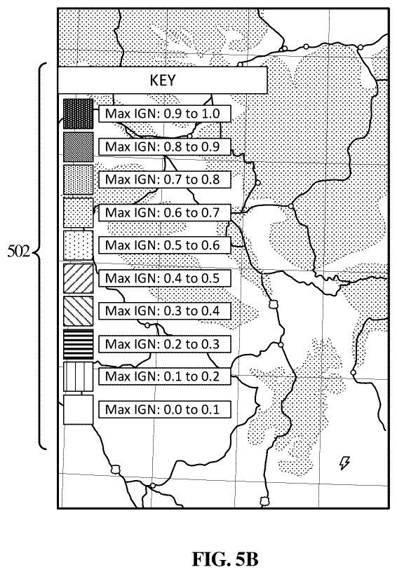

FIGS. 5A and 5B illustrate user interface 501 hosted by an ignition potential prediction system, such as ignition prediction system 120 of FIG. 1, in an implementation. As illustrated, a geographic area of interest is mapped in user interface 501 and lightning events are indicated with lightning bolt icons, such as lightning bolt icon 503. The geographic map is also overlaid with a rectangular grid. The sectors may be color-coded or shaded to visually indicate calculated ignition potentials. For example, as depicted in FIGS. 5A and 5B, the sectors of the rectangular grid, such as sector 504, are shaded according to calculated ignition potentials indicated in legend 502 in the upper left corner. Other user interface configurations are of course possible. A close-up view of legend 502 is depicted in FIG. 5B. In legend 502, the shading provides a visual indication of the maximum ignition potential computed for the sectors based on lightning event data, weather data, topographical data, and/or fuels data.

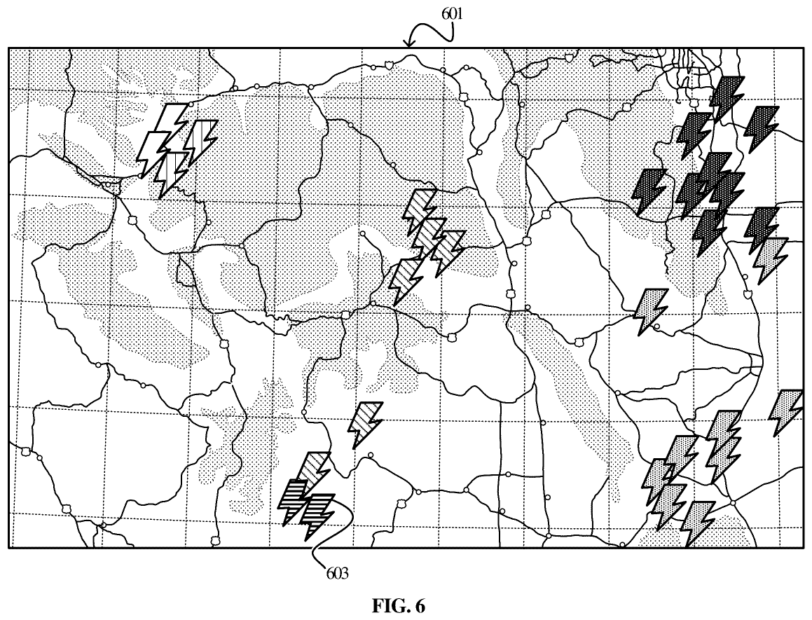

FIG. 6 illustrates an implementation of user interface 601 for displaying a fusion or integrated representation of information from lightning event data obtained from a sensor with ignition potential information. User interface 601 may be hosted by an ignition potential prediction system, such as ignition prediction system 120 of FIG. 1, which receives and processes lightning event data with environmental data to predict an ignition potential. The lightning event data is obtained from a ground-based sensor or a space-based detector, such as the GLM lightning detector. User interface 601 presents the information from the detector and prediction systems based at least on a fusion or integration of the key information about lightning events for a unified and highly consumable display.

As illustrated in FIG. 6, in a geographic area of interest displayed in the user interface 601, lightning events are indicated with a lightning bolt icon (e.g., lightning bolt icon 603) which may be color-coded or shaded according to an ignition potential calculated by the ignition potential prediction system, for example, as depicted in legend 502 of FIGS. 5A and 5B. In an implementation, event data relating to a lightning event detected by a ground-based detector is fed into the ignition potential prediction system along with data relating to environmental factors identified according to the event time and location. The ignition potential prediction system, such as an artificial intelligence model trained on historical lightning event data and environmental data, determines an ignition potential based on the lightning event data and corresponding environmental factors. The system fuses or combines the information from the ground-based lightning detector with the output of the ignition potential prediction system and updates user interface 603 to indicate the geographic location of the lightning event and color codes or shades the lightning bolt icon to reflect the calculated ignition potential.

Turning now to FIG. 7, architecture 700 illustrates computing device 701 that is representative of any system or collection of systems in which the various processes, programs, services, and scenarios disclosed herein may be implemented. Examples of computing device 701 include, but are not limited to, server computers, web servers, cloud computing platforms, and data center equipment, as well as any other type of physical or virtual server machine, container, and any variation or combination thereof. Examples also include desktop and laptop computers, tablet computers, mobile computers, and wearable devices.

Computing device 701 may be implemented as a single apparatus, system, or device or may be implemented in a distributed manner as multiple apparatuses, systems, or devices. Computing device 701 includes, but is not limited to, processing system 702, storage system 703, software 705, communication interface system 707, and user interface system 709 (optional). Processing system 702 is operatively coupled with storage system 703, communication interface system 707, and user interface system 709.

Processing system 702 loads and executes software 705 from storage system 703. Software 705 includes applications 710, which are representative of the processes and services, and platforms discussed with respect to the included Figures. Applications 710 includes ignition potential process 711, which is representative of the ignition prediction processes discussed with respect to the preceding Figures, such as process 200. When executed by processing system 702, software 705 directs processing system 702 to operate as described herein for at least the various processes, operational scenarios, and sequences discussed in the foregoing implementations. Computing device 701 may optionally include additional devices, features, or functions not discussed for purposes of brevity.

Referring still to FIG. 7, processing system 702 may comprise a microprocessor and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, graphical processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 (including applications 710, operating system software 720, and data 730) may be implemented in program instructions and among other functions may, when executed by processing system 702, direct processing system 702 to operate as described with respect to the various operational scenarios, sequences, and processes illustrated herein. For example, software 705 may include program instructions for implementing the ignition potential processes as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing device 701 is representative) overall from a general-purpose computing system into a special-purpose computing system customized to support ignition potential processes. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary, etc.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Applications 710 may include ignition potential process 711 and lightning event detection process 712. Ignition potential process 711 may direct the operation of processing system 702 to generate ignition potentials based on lightning event data, such as lightning event data 731. Ignition potential process 711 may also direct user interface system 709 to cause display of user interfaces, user experiences, dashboards, etc., of an ignition potential system. Applications 710 may also include lightning event detection process 712. Lightning event detection process 712 may direct the operation processing system 702 to detect lightning events. Lightning event detection process 712 may generate data, such as lightning event data 731 which is processed by ignition potential process 711.

Data 730 may include various information related to lightning events, e.g., lightning event data 731, as well as fuels data, topographical data, and weather data. Lightning event data 731 can include output from lightning event detection process 712, satellite sensing data, or sensing data from airborne or ground-based devices, among other sources.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The wireless data network circuitry described above comprises computer hardware and software that form special-purpose wireless system circuitry to serve wireless user devices based on policies. The computer hardware comprises processing circuitry like CPUs, DSPs, GPUs, transceivers, bus circuitry, and memory. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically embedded machine-level software that drives the compilation and execution of the other computer software components which then assert control. Due to this automated execution, the presence of the higher-level software in memory physically changes the structure of the computer hardware machines into special-purpose wireless system circuitry to serve wireless user devices based on policies.

The following illustrative examples are now mentioned, but are not included to limit or define the scope of the disclosure but rather to provide examples to aid understanding thereof. Illustrative examples are discussed above in the Detailed Description which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a method of operating a computing system to predict an ignition potential of a lightning event, the method comprising, in the computing system: obtaining data associated with the lightning event, wherein the data includes a location of the lightning event and one or more measurements of the lightning event captured by a sensor; identifying attributes of the lightning event based at least on the one or more measurements included in the data; and predicting the ignition potential of the lightning event based at least on the lightning event attributes and one or more environmental factors associated with the location.

Example 2 is the method of any previous or subsequent Example, wherein the attributes of the lightning event comprise a time, a duration, the location, and intensity parameters of the lightning event.

Example 3 is the method of any previous or subsequent Example, wherein the one or more environmental factors associated with the location comprise at least one among fuels characteristics, weather data, and topographical data.

Example 4 is the method of any previous or subsequent Example, wherein the data comprises data from a space-based lightning detector.

Example 5 is the method of any previous or subsequent Example, wherein the ignition potential comprises an indication of a potential of ignition at an area corresponding to the location.

Example 6 is the method of any previous or subsequent Example, wherein the data comprises optical or infrared sensor data.

Example 7 is the method of any previous or subsequent Example, wherein the method further comprises generating a map for display in a user interface, wherein the map includes the location of the lightning event and the ignition potential.

Example 8 is the method of any previous or subsequent Example, wherein the location of the lightning event is color-coded according to the ignition potential.

Example 9 is a computing apparatus comprising one or more computer readable storage media; one or more processors operatively coupled with the one or more computer readable storage media; and an application comprising program instructions stored on the one or more computer readable storage media that, when executed by the one or more processors, direct the computing apparatus to at least obtain data associated with a lightning event, wherein the data includes a location of the lightning event and one or more measurements of the lightning event captured by a sensor; identify attributes of the lightning event based at least on the one or more measurements included in the data; and predict an ignition potential of the lightning event based at least on the lightning event attributes and one or more environmental factors associated with the location.

Example 10 is the computing apparatus of any previous or subsequent Example, wherein the attributes of the lightning event include a time, a duration, the location, and intensity parameters.

Example 11 is the computing apparatus of any previous or subsequent Example, wherein the one or more environmental factors associated with the location comprise at least one among fuels characteristics, weather data, and topographical data.

Example 12 is the computing apparatus of any previous or subsequent Example, wherein the data comprises data from a space-based lightning detector.

Example 13 is the computing apparatus of any previous or subsequent Example, wherein the ignition potential comprises an indication of a potential of ignition at an area corresponding to the location.

Example 14 is the computing apparatus of any previous or subsequent Example, wherein the data comprises optical or infrared sensor data.

Example 15 is the computing apparatus of any previous or subsequent Example, wherein the program instructions further direct the computing apparatus to generate a map for display in a user interface, wherein the map includes the location of the lightning event and the ignition potential.

Example 16 is the computing apparatus of any previous or subsequent Example, wherein the location of the lightning event is color-coded according to the ignition potential.

Example 17 is one or more computer-readable storage media having program instructions stored thereon that, when executed by one or more processors of a computing device, direct the computing device to at least: obtain data associated with a lightning event, wherein the data includes a location of the lightning event and one or more measurements of the lightning event captured by a sensor; identify attributes of the lightning event based at least on the one or more measurements included in the data; identify environmental factors associated with the location; and predict an ignition potential of the lightning event based at least on the attributes and characteristics of the lightning event and the environmental factors.

Example 18 is the one or more computer-readable storage media of any previous or subsequent Example, wherein to identify the attributes of the lightning event, the program instructions direct the computing device to identify the unique attributes and characteristics of the event based on optical properties of the lightning event derived from the data.

Example 19 is the one or more computer-readable storage media of any previous or subsequent Example, wherein the ignition potential comprises an indication of a potential of ignition at an area corresponding to the location.

Example 20 is the one or more computer-readable storage media of any previous or subsequent Example, wherein the environmental factors associated with the location comprise at least one among fuels characteristics, weather data, and topographical data.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method of operating a computing system to predict an ignition potential of a lightning event, the method comprising:
in the computing system:
obtaining data associated with the lightning event, wherein the data includes a location of the lightning event and one or more measurements of the lightning event captured by a sensor;
identifying attributes of the lightning event based at least on the one or more measurements included in the data; and
predicting the ignition potential of the lightning event based at least on the lightning event attributes and one or more environmental factors associated with the location.

2. The method of claim 1, wherein the attributes of the lightning event comprise a time, a duration, the location, and intensity parameters of the lightning event.

3. The method of claim 1, wherein the one or more environmental factors associated with the location comprise at least one among fuels characteristics, weather data, and topographical data.

4. The method of claim 1, wherein the data comprises data from a space-based lightning detector.

5. The method of claim 1, wherein the ignition potential comprises an indication of a potential of ignition at an area corresponding to the location.

6. The method of claim 1, wherein the data comprises optical or infrared sensor data.

7. The method of claim 1, further comprising generating a map for display in a user interface, wherein the map includes the location of the lightning event and the ignition potential.

8. The method of claim 7, wherein the location of the lightning event is color-coded according to the ignition potential.

9. A computing apparatus comprising:
one or more computer readable storage media;
program instructions stored on the one or more computer readable storage media that, when executed by one or more processors, direct the computing apparatus to at least:
obtain data associated with a lightning event, wherein the data includes a location of the lightning event and one or more measurements of the lightning event captured by a sensor;
identify attributes of the lightning event based at least on the one or more measurements included in the data; and
predict an ignition potential of the lightning event based at least on the lightning event attributes and one or more environmental factors associated with the location.

10. The computing apparatus of claim 9, wherein the attributes of the lightning event include a time, a duration, the location, and intensity parameters.

11. The computing apparatus of claim 9, wherein the one or more environmental factors associated with the location comprise at least one among fuels characteristics, weather data, and topographical data.

12. The computing apparatus of claim 9, wherein the data comprises data from a space-based lightning detector.

13. The computing apparatus of claim 9, wherein the ignition potential comprises an indication of a potential of ignition at an area corresponding to the location.

14. The computing apparatus of claim 9, wherein the data comprises optical or infrared sensor data.

15. The computing apparatus of claim 9, wherein the program instructions further direct the computing apparatus to generate a map for display in a user interface, wherein the map includes the location of the lightning event and the ignition potential.

16. The computing apparatus of claim 15, wherein the location of the lightning event is color-coded according to the ignition potential.

17. One or more computer-readable storage media having program instructions stored thereon that, when executed by one or more processors of a computing device, direct the computing device to at least:
obtain data associated with a lightning event, wherein the data includes a location of the lightning event and one or more measurements of the lightning event captured by a sensor;
identify attributes of the lightning event based at least on the one or more measurements included in the data;
identify environmental factors associated with the location; and
predict an ignition potential of the lightning event based at least on the attributes and characteristics of the lightning event and the environmental factors.

18. The one or more computer-readable storage media of claim 17, wherein to identify the attributes of the lightning event, the program instructions direct the computing device to identify the unique attributes and characteristics of the event based on optical properties of the lightning event derived from the data.

19. The one or more computer-readable storage media of claim 17, wherein the ignition potential comprises an indication of a potential of ignition at an area corresponding to the location.

20. The one or more computer-readable storage media of claim 17, wherein the environmental factors associated with the location comprise at least one among fuels characteristics, weather data, and topographical data.
